(19) United States
(12) Patent Application Publication
(10) Pub. No.: US 2025/0291878 A1
(43) Pub. Date: Sep. 18, 2025

(54) LOW MEMORY NTH PERCENTILE COMPUTATION

(71) Applicant: MELLANOX TECHNOLOGIES, LTD., Yokneam (IL)

(72) Inventor: Liron Mula, Herzliya (IL)

(21) Appl. No.: 18/608,777

(22) Filed: Mar. 18, 2024

(51) Int. Cl. G06F 17/18

(52) U.S. Cl. CPC G06F 17/18

(57) ABSTRACT

A device, systems, and method are described which provide low memory determination of an nth percentile. The device, systems, and method include receiving user input indicating a percentile (n) to be approximated for a measurement. The device, systems, and method further include initializing an nth-percentile estimator to an initial value and using a control loop to update the nth-percentile estimator until n% of samples are lower than the nth-percentile estimator and 100%-n% of samples are higher than the nth-percentile estimator, wherein for each value in a set of data, the nth-percentile estimator is updated based on whether each value is higher or lower than the nth-percentile estimator.

### FIELD OF THE DISCLOSURE

The present disclosure is generally directed to systems, methods, and devices for computing an nth percentile and, in particular, for providing memory efficient, control loop based, nth percentile approximation.

### BACKGROUND

In statistics, an nth percentile is a value that a given percentage N of values in a frequency distribution falls below (e.g., “exclusive”) or the given percentage N of values that fall at or below (e.g., “inclusive”). Percentiles are expressed in the same unit of measurement as the input values, not as a percentage (%). For example, if the values refer to human weight, the corresponding percentiles will be expressed in kilograms or pounds.

The 25th percentile is also known as the first quartile (Q1), the 50th percentile as the median or second quartile (Q2), and the 75th percentile as the third quartile (Q3). For example, the 50th percentile (median) is the value below or at which 50% of the values in the distribution are found.

A related quantity is the percentile rank of a value, expressed in percent, which represents the fraction of values in its distribution that are less than it. For percentile ranks, a value is given and a percentage is computed. Percentile ranks are exclusive: if the percentile rank for a specified value is 90%, then 90% of the values were lower. In contrast, for percentiles a percentage is given and a corresponding value is determined, which can be either exclusive or inclusive. The value for a specified percentage (e.g., 90th) indicates a value below which (exclusive definition) or at or below which (inclusive definition) other values in the distribution fall.

For example, an Internet Service Provider (ISP) may want to guarantee that 99% of the time, their customers' needs will be served. In order to do this the ISP can measure its clients' requested bandwidth and determine the 99th percentile of requested bandwidth, which means that 99% of the time the bandwidth usage is below this amount, and the remaining 1% of the time the bandwidth usage is above that amount. Once the percentile is determined, the ISP can purchase an Internet connection as wide as 99% of the peak demand to ensure their clients' needs are met without purchasing bandwidth above their needs.

### BRIEF SUMMARY

The present disclosure provides a device, system, and method to approximate the nth percentile of some distribution, without storing each and every value in a data set. Advantageously, the present disclosure is able to approximate the nth percentile without using a large memory footprint. By efficiently using memory, application performance may be increased. Application performance is determined by some bottleneck of that application (e.g., an application is performance-limited by the latency-jitter of the network that delivers the application-information between endpoints). Therefore, decreasing network latency will increase application performance. To optimize the network latency, the network latency must be measured.

Modern networks carry a large number of packets/second (e.g., 1E7 packets/second), therefore, exporting latency numbers from a network device requires large bandwidth and high-cable circuitry to collect, store, and drive this information externally. Such mechanisms are expensive. As a result, the latency numbers may either not be collected/exported, or only a subset of the information may be collected/exported, leading to inaccuracies. Many times, the application only cares about the “tail” of an underlying distribution (e.g., forwarding latency, buffer occupancy, memory access latency, etc.), where the tail indicates the worst observation seen. The application requires the “tail” of the distribution, because this is the largest limit to the application performance, and optimizing that tail will generate the best gain/effort. It is a common practice to measure the single worst event observed and try to optimize that; but in practice, the single worst event observed is a single event that may only occur once, and therefore eliminating the single worst event may only generate a small gain. Therefore, it is more useful to reduce the 99% percentile (or 99.99% percentile), which is assumed to occur more times than the 100% percentile (e.g., the single worst event).

However, to optimize the 99.9% percentile of an underlying distribution (e.g., forwarding latency, buffer occupancy, memory access latency, etc.), it first needs to be measured. A common method for measuring the nth percentile requires collecting raw data as histograms and searching for the nth percentile in the histogram. The “finer” the resolution of the tail (as in 99.9% is finer than 99%, which is finer than 90%; and 55.5432345% is the tiniest of them all) the more information is needed and stored before a computation is made. For example, to detect the 90% percentile, at least 10% of samples are required, which will yield a very coarse estimation of the 90% percentile. Furthermore, a common practice is to sample 5× the minimum number of samples. Therefore, for the 90% percentile 5×10 samples=50 samples are stored; and for the 99% percentile=500 samples are stored; for 55.1% percentile=5,000 samples are stored, because of the 0.1% accuracy requirement. The memory overhead of storing the large number of samples required to calculate the nth percentile is undesired for ASIC mechanisms, which have small memory allocation.

Therefore, the present disclosure approximates the nth percentile of a distribution using one memory slot. The present disclosure uses a control loop to estimate the nth percentile. The present disclosure gradually adjusts the nth-percentile estimator up/down, until N% of the samples are smaller than the nth-percentile estimator, and (100%−n%) of the samples are larger than the nth-percentile estimator.

For example, if the target percentile is very high (e.g., 99%), then 99% of the samples should be below the nth-percentile estimator, and only 1% of the samples will be higher than the nth-percentile estimator. Once the nth-percentile estimator is correct, there may only be minor back-and-forth adjustments, such that, if the machine adjusts the estimator for a fraction of the samples that are below the nth-percentile estimator, and the machine adjusts the nth-percentile estimator for all the samples that are above the nth-percentile estimator, the nth-percentile estimator will move up/down an equal number of times (practically staying in place).

In embodiments, a random-number-generator or a pseudo-random number generator may be used. Random number generators can be truly random hardware random generators (HRNGS), which generate random numbers as a function of current value of some physical environment attribute that is constantly changing in a manner that is practically impossible to model, or pseudo-random number generators (PRNGS), which generate numbers that look random, but are actually deterministic, and can be reproduced if the state of the PRNG is known. In some applications, the random number generator uses computational algorithms that can produce long sequences of apparently random results, which are in fact determined by a shorter initial value, known as a seed value or key. Embodiments disclosed herein are not limited by any method of type of random or pseudo-random number generation.

Assuming the ask is to measure the x% percentile, the system initializes/sets one memory element to zero. For each new sample, the system compares the new sample to the estimator:

If (new sample)>(estimator) [herein after case 1], then y=gen random number in range 0 . . . 1; and if y<x (which will happen x% of the times) then estimator+=some-parameter. If (new sample)<(estimator) [herein after case 2], then y=gen random number in range 0 . . . 1; and if y>x (which will happen (100%−x%) of the times, then estimator−=some-parameter.

For example, if x=70% percentile, assuming the estimator is accurate, then −70% of the samples will be smaller than the estimator (case 2), of which 30% of the samples will reduce the estimator; and −30% of the samples will be larger than the estimator (case 1), of which 70% of the samples will increase the estimator, such that the estimator will stay in its appropriate value (+/−small adjustments).

Embodiments of the present disclosure include a device, the device comprising: an interface to receive user input indicating a percentile (n) to be approximated for a measurement; and processing circuitry to: initialize an nth-percentile estimator to an initial value; and use a control loop to update the nth-percentile estimator until n% of samples are lower than the nth-percentile estimator and 100%−n% of samples are higher than the nth-percentile estimator, wherein for each value in a set of data, the nth-percentile estimator is updated based on whether each value is higher or lower than the nth-percentile estimator.

Embodiments of the present disclosure include a system comprising a communication interface to receive user input of a number indicating a percentile (n) to be approximated for a measurement; and processing circuitry to: initialize a memory slot to an initial value for an nth-percentile estimator; and process, using a control loop, each value in a set of data and updating the nth-percentile-estimator based on whether each value is higher or lower than the nth percentile estimator.

Embodiments of the present disclosure also include a method comprising receiving user input indicating a percentile (n) to be approximated for a measurement; initializing an nth-percentile estimator to an initial value; and using a control loop to update the nth-percentile estimator until n% of samples are lower than the nth-percentile estimator and 100%−n% of samples are higher than the nth-percentile estimator, wherein for each value in a set of data, the nth-percentile estimator is updated based on whether each value is higher or lower than the nth-percentile estimator.

Aspects of the above device, systems, and method include wherein the nth-percentile estimator is initialized to zero.

Aspects of the above device, systems, and method include wherein if a value in the set of data is higher than the nth-percentile estimator, then updating the nth-percentile estimator comprises increasing the nth-percentile estimator.

Aspects of the above device, systems, and method include wherein increasing the nth-percentile estimator comprises: generating a random number x between 0-1; and if the random number x is less than

$$( \frac{n}{100} ) ,$$

then increasing the nth-percentile estimator by a given magnitude.

Aspects of the above device, systems, and method include wherein increasing the nth-percentile estimator comprises randomizing an integer between 1 . . . 2^{∧}k (for some large k e.g., 32) and multiplying x% by 2^{∧}k, and rounding to the nearest integer (e.g., if x%=0.7 and k=32 randomizing an integer of 32b, i.e. the value will be 1,234,567,890 and X%*2^{∧}32=3006477107.2 (rounded down).

Aspects of the above device, systems, and method include wherein if a value in the set of data is lower than the nth-percentile estimator, then updating the nth-percentile estimator comprises decreasing the initial value.

Aspects of the above device, systems, and method include wherein decreasing the nth-percentile estimator comprises: generating a random number x between 0-1; and if the random number x is greater than

$$( \frac{100 - n}{100} ) ,$$

then decreasing the nth-percentile estimator by a given magnitude.

Aspects of the above device, systems, and method include wherein decreasing the nth-percentile estimator comprises randomizing an integer between 1 . . . 2^{∧}k (for some large k e.g., 32) and multiplying x% by 2^{∧}k, and rounding to the nearest integer

Aspects of the above device, systems, and method include wherein the measurement comprises one of: packet latency, queue length, buffer occupancy, forwarding latency, or memory access latency.

Aspects of the above device, systems, and method include wherein the measurement comprises packet latency.

Aspects of the above device, systems, and method include wherein the measurement comprises queue length.

Aspects of the above device, systems, and method include wherein the measurement comprises buffer occupancy.

Aspects of the above device, systems, and method include wherein the measurement comprises forwarding latency.

Aspects of the above device, systems, and method include wherein the measurement comprises memory access latency.

Aspects of the above device, systems, and method include wherein the measurement is an integer.

Aspects of the above device, systems, and method include any one or more of the features as substantially disclosed herein in combination with any one or more other features as substantially disclosed herein.

Aspects of the above device, systems, and method include any one of the aspects/features/embodiments in combination with any one or more other aspects/features/embodiments.

Aspects of the above device, systems, and method include any use of any one or more of the aspects or features as disclosed herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Additional features and advantages are described herein and will be apparent from the following Description and the figures.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

The present disclosure is described in conjunction with the appended figures, which are not necessarily drawn to scale:

FIG. 1 is a block diagram of a system memory in accordance with one or more of the embodiments described herein;

FIG. 2 is a block diagram of a computing system in accordance with one or more of the embodiments described herein; and

FIG. 3 is a flowchart of a method in accordance with one or more of the embodiments described herein.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The details of one or more aspects of the disclosure are set forth in the accompanying drawings and the description below. Other features, objects, and advantages of the techniques described in this disclosure will be apparent from the description and drawings, and from the claims.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1−Xn, Y1−Ym, and Z1−Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The preceding Summary is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

It will be appreciated from the following description, and for reasons of computational efficiency, that the components of the system can be arranged at any appropriate location within a distributed network of components without impacting the operation of the system.

Further, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The terms “determine,” “calculate,” and “compute,” and variations thereof, as used herein, are used interchangeably, and include any appropriate type of methodology, process, operation, or technique.

Various aspects of the present disclosure will be described herein with reference to drawings that may be schematic illustrations of idealized configurations.

Any of the steps, functions, and operations discussed herein can be performed continuously and automatically.

The systems and methods of this disclosure have been described in relation to a network of switches; however, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases may not necessarily refer to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The use of GPUs as a means to offload computationally-intensive tasks from CPUs and the use of networks of computing nodes to implement computationally-intensive tasks, whether executed by CPUs or GPUs, is increasingly important to users such as scientific researchers seeking to execute artificial intelligence (AI) models and other computationally-intensive processes. The growing demand for high-performance computing in various domains, including scientific simulations, machine learning, and image processing, has driven the need for efficient and cost-effective computational resources. The limitations of network communication performance and the increasing importance of parallelism have prompted researchers and other users to explore alternatives to the use of single computing devices for performing data processing. As a result, GPUs have emerged as an approach to offload computationally-intensive tasks from CPUs, and networks of computing systems have become useful for executing complex processing applications.

By using a system or method as described herein, connections and communications between computing systems or nodes may be managed to improve memory requirements and consumption and to lessen latency. Through the systems and methods described herein, a computing device communicating with one or more peers may be enabled to estimate an nth percentile of some network parameter in order to improve network performance.

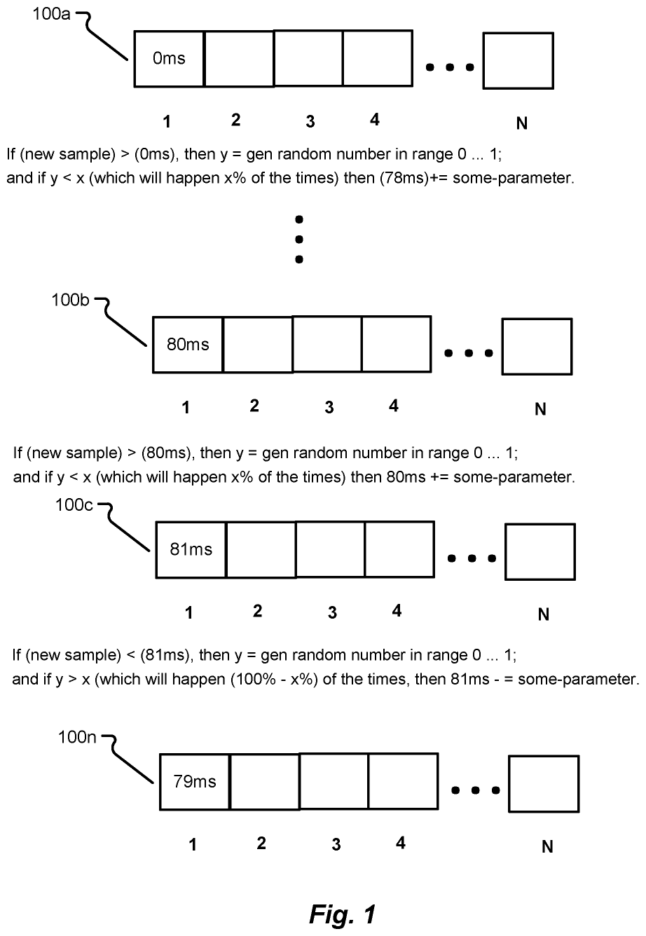

FIG. 1 illustrates a memory block 100 after each operation (a-n). The memory block 100 has slots 1−n, slot 1 is used to store a value for the nth-percentile estimator. Advantageously, the amount of memory needed to calculate the nth-percentile estimator of a dataset is reduced because the system does not need to store all the values in the dataset in order to calculate the nth-percentile estimator.

For example, the system is configured to determine the 99% percentile of latency in a network, the system initializes/sets one memory element (e.g., slot 1) to zero (100a).

For each new sample (100a-n), the system compares the new sample to the estimator, If (new sample)>(estimator), then y=gen random number in range 0 . . . 1; and if y<x (which will happen x% of the times) then estimator+=some parameter. If (new sample)<(estimator), then y=gen random number in range 0 . . . 1; and if y>x (which will happen (100%−x%) of the times, then estimator−=some parameter.

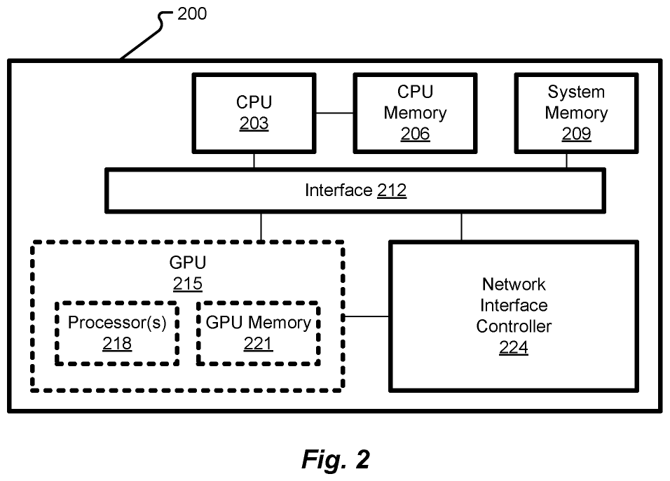

FIG. 2 is a block diagram illustrating components of a computing system 200 which, according to some example implementations, may be capable of performing any one or more of the methods discussed herein.

As illustrated in FIG. 2, each computing system 100 may include one or more CPUs 203, one or more GPUs 215, and one or more NICs 224. Each of the CPUs 203, GPUs 215, and NICs 224 may communicate via an interface 212.

The NIC 224 of the computing system 200 may comprise one or more circuits capable of acting as an interface between components of the computing system 100, such as the CPU 203 and the GPU 215, and the network 103. A NIC 224 may comprise one or more of a peripheral component interconnect express (PCIe) card, a USB adapter, and/or may be integrated into a PCB such as a motherboard. The NIC 224 may be capable of supporting any number of network protocols such as Ethernet, Wi-Fi, fiber channel, etc.

One or more CPUs 203 of the computing system 200 may each comprise one or more circuits capable of executing instructions and performing calculations. The CPUs 203 may be capable of interpreting and processing data received by the computing system 200 via the NIC 224. CPUs 203 of a computing system 200 may each comprise one or more arithmetic logic units (ALUs) capable of performing arithmetic and/or logical operations, such as addition, subtraction, and bitwise operations. The CPUs 203 may also or alternatively comprise one or more control unit (CUs) which may be capable of managing the flow of instructions and data within the CPU 203. CUs of the CPU 203 may be configured to fetch instructions from CPU memory 206 or system memory storage device(s) 209, decode the instructions, and direct appropriate components to execute operations based on the instructions.

A CPU 203 of the computing system 200 may include, for example, a CPU, a reduced instruction set computing (RISC) processor, a complex instruction set computing (CISC) processor, a GPU, a digital signal processor (DSP) such as a baseband processor, an application-specific integrated circuit (ASIC), a field-programmable gate array (FPGA), a radio-frequency integrated circuit (RFIC), another processor (including those discussed herein), or any suitable combination thereof. Similarly, a GPU 215 as described herein may include a processor 218 such as a streaming multiprocessor (SM), a CPU, a RISC processor, a CISC processor, a DSP, a baseband processor, an ASIC, an FPGA, an RFIC, another processor (including those discussed herein), or any suitable combination thereof.

A CPU 203 and/or a processor 218 of a GPU 215 as described herein may incorporate multiple processing cores, allowing the CPU 203 (and/or the GPU 215) to execute multiple instructions simultaneously, and/or may be capable of performing hyperthreading to execute multiple threads concurrently.

One or more GPUs 215 of the computing system 200 may each comprise one or more circuits capable of acting as specialized processing components to handle computationally-intensive tasks, such as rendering graphics and performing complex mathematical calculations. GPUs 215 may be capable of parallel execution of general-purpose tasks alongside the CPUs 203.

Each GPU 215 may comprise one or more streaming multiprocessors (SMs), CUs, or processors 218, which may be responsible for executing instructions in parallel. Each SM, CU, or processor 218 of a GPU 215 may contain one or more processing cores or ALUs which may be capable of performing arithmetic and/or logical operations concurrently.

Each GPU 215 of the computing system 200 may be capable of executing tasks such as scientific simulations, machine learning, and data analysis. For example, a GPU 215 of the computing system 200 may be designed for operation in workstation environments, such as for performing scientific simulations, executing and/or training machine learning models, performing data analysis, etc.

The GPU 215 may execute one or more kernels. Kernels executed by the GPU 215 may perform specific, parallelizable tasks on the GPU 215. Such kernels may be written using GPU programming languages or frameworks, such as CUDA.

The interface 212 of the computing system 200 may comprise one or more circuits capable of connecting peripheral devices such as the NIC 224, one or more GPUs 215, and one or more CPUs 203 to a motherboard of the computing system 200, as well as one or more memory storage devices (e.g., 206 and 209). The interface 212 of the computing system 200 may comprise one or more high-speed lanes. Each lane may be, for example, a serial lane, and may consist of a pair of signaling wires for transmitting and/or receiving data. The interface 212 may be, for example, a PCIe bus.

The computing system 200 may further comprise one or more system memory storage devices 209, such as NVMe solid-state drives (SSDs). The system memory storage devices 209 may be capable of providing fast and efficient data access and storage. Each of the NIC 224, CPU 203, and GPU 215 may be capable of sending data to and reading data from the system memory storage devices 209 via the interface 212. Each of the NIC 224, the CPU 203, and the GPU 215 may also comprise one or more dedicated memory devices such as CPU memory 206 and GPU memory 221.

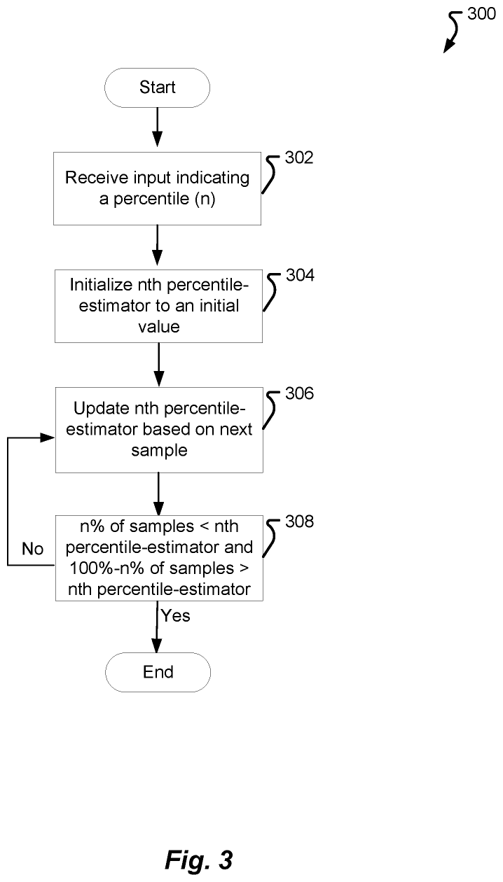

In some embodiments, the electronic device(s), network(s), system(s), chip(s), circuit(s), or component(s), or portions or implementations thereof of FIGS. 1-2 or some other figure herein, may be configured to perform one or more processes, techniques, or methods as described herein, or portions thereof. Such processes may be as depicted in FIG. 3 and as described below.

The method 300 may begin at step 302, at which time an input indicating a percentile (n) to be determined is received. For example, the system may be configured to determine the 99% percentile latency.

At step 304, the nth percentile-estimator is initialized to an initial value. In embodiments, previous values for the parameter to be calculated are used as the initial value. In other embodiments, the initial value is zero. In other embodiments, the initial value is set to the current sample.

At 306, the nth percentile-estimator is updated based on the next sample. For each new sample, the system compares the new sample to the estimator: If (new sample)>(estimator), then y=gen random number in range 0 . . . 1; and if y<x (which will happen x% of the times) then estimator+=a value. If (new sample)<(estimator), then y=gen random number in range 0 . . . 1; and if y>x (which will happen (100%−x%) of the times, then estimator−=a value.

At step 308, if N% of samples<nth percentile-estimator and 100%−N% of samples>nth-percentile estimator (Yes), then the method 300 ends. If N% of samples is not less than the nth-percentile estimator or 100%−N% of samples is not greater than the nth-percentile estimator (No), then method 300 continues to update the nth-percentile estimator based on the next sample (step 306).

The present disclosure encompasses embodiments of the method 300 that comprise more or fewer steps than those described above, and/or one or more steps that are different than the steps described above.

The present disclosure encompasses methods with fewer than all of the steps identified in FIG. 3 (and the corresponding description of the method), as well as methods that include additional steps beyond those identified in FIG. 3 (and the corresponding description of the method). The present disclosure also encompasses methods that comprise one or more steps from one method described herein, and one or more steps from another method described herein. Any correlation described herein may be or comprise a registration or any other correlation.

The details of one or more aspects of the disclosure are set forth in the accompanying drawings and the description below. Other features, objects, and advantages of the techniques described in this disclosure will be apparent from the description and drawings, and from the claims.

It is to be appreciated that any feature described herein can be claimed in combination with any other feature(s) as described herein, regardless of whether the features come from the same described embodiment.

It is to be appreciated that any feature described herein can be claimed in combination with any other feature(s) as described herein, regardless of whether the features come from the same described embodiment.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMS, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22nm Haswell, Intel® Core® i5-3570K 22nm Ivy Bridge, the AMD® FX™ family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed clement(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A device to approximate an nth percentile, the device comprising:
an interface to receive user input indicating a percentile (n) to be approximated for a measurement; and
processing circuitry to:
initialize an nth-percentile estimator to an initial value; and
use a control loop to update the nth-percentile estimator until n% of samples are lower than the nth-percentile estimator and 100%−n% of samples are higher than the nth-percentile estimator, wherein for each value in a set of data, the nth-percentile estimator is updated based on whether each value is higher or lower than the nth-percentile estimator.

2. The device of claim 1, wherein the nth-percentile estimator is initialized to zero.

3. The device of claim 1, wherein if a value in the set of data is higher than the nth-percentile estimator, then updating the nth-percentile estimator comprises increasing the nth-percentile estimator.

4. The device of claim 3, wherein increasing the nth-percentile estimator comprises:
generating a random number x between 0-1; and
if the random number x is less than
$$( \frac{n}{100} ) ,$$
then increasing the nth-percentile estimator by a given magnitude.

5. The device of claim 1, wherein if a value in the set of data is lower than the nth-percentile estimator, then updating the nth-percentile estimator comprises decreasing the initial value.

6. The device of claim 5, wherein decreasing the nth-percentile estimator comprises:
generating a random number x between 0-1; and
if the random number x is greater than
$$( \frac{100 - n}{100} ) ,$$
then decreasing the nth-percentile estimator by a given magnitude.

7. The device of claim 1, wherein the measurement comprises one of: packet latency, queue length, buffer occupancy, forwarding latency, or memory access latency.

8. A system to approximate an nth percentile, the system comprising:
a communication interface to receive user input of a number indicating a percentile (n) to be approximated for a measurement; and
processing circuitry to:
initialize a memory slot to an initial value for an nth-percentile estimator; and
process, using a control loop, each value in a set of data and updating the nth-percentile estimator based on whether each value is higher or lower than the nth-percentile estimator.

9. The system of claim 8, wherein the nth-percentile estimator is initialized to zero.

10. The system of claim 8, wherein if a value in the set of data is higher than the nth-percentile estimator, then updating the nth-percentile estimator comprises increasing the nth-percentile estimator.

11. The system of claim 10, wherein increasing the nth-percentile estimator comprises:
generating a random number x between 0-1; and
if the random number x is less than
$$( \frac{n}{100} )$$
then increasing the nth-percentile estimator by a given magnitude.

12. The system of claim 8, wherein if a value in the set of data is lower than the nth-percentile estimator, then updating the nth-percentile estimator comprises decreasing the nth-percentile estimator.

13. The system of claim 12, wherein decreasing the nth-percentile estimator comprises:
generating a random number x between 0-1; and
if the random number x is greater than
$$( \frac{100 - n}{100} ) ,$$
then decreasing the nth-percentile estimator by a given magnitude.

14. The system of claim 8, wherein the measurement comprises packet latency.

15. The system of claim 8, wherein the measurement comprises queue length.

16. The system of claim 8, wherein the measurement comprises buffer occupancy.

17. The system of claim 8, wherein the measurement comprises forwarding latency.

18. The system of claim 8, wherein the measurement comprises memory access latency.

19. The system of claim 8, wherein the measurement is an integer.

20. A method of approximating an nth percentile, the method comprising:
receiving user input indicating a percentile (n) to be approximated for a measurement;
initializing an nth-percentile estimator to an initial value; and
using a control loop to update the nth-percentile estimator until n% of samples are lower than the nth-percentile estimator and 100%−n% of samples are higher than the nth-percentile estimator, wherein for each value in a set of data, the nth-percentile estimator is updated based on whether each value is higher or lower than the nth-percentile estimator.
